(19) United States
(12) Patent Application Publication
(10) Pub. No.: US 2009/0174624 A1
(43) Pub. Date: Jul. 9, 2009

(54) DISPLAY APPARATUS

(75) Inventors: LI-SHENG SHU, Shenzhen (CN); CHUNG-JEN WANG, Tu-Cheng (TW); WEN-HAW TSENG, Tu-Cheng (TW); SHIH-FANG WONG, Tu-Cheng (TW)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/968,654

(22) Filed: Jan. 3, 2008

(51) Int. Cl. G09G 3/20

(52) U.S. Cl. 345/55

(57) ABSTRACT

A display panel includes a display panel and a front cover. The display panel is used for displaying images. The front cover is attached to the display panel and arranged with a plurality of hybrid modules. The hybrid modules is used for sensing primary light emitted from side portions of the display panel and emitting secondary light with substantially same color and luminous intensity in different directions from the primary light.

### BACKGROUND

1. Field of the Invention

The present invention generally relates to display apparatuses, and particularly, to a display apparatus capable of displaying extending images.

2. Description of Related Art

Display apparatuses, particularly flat panel display apparatuses, are widely used in various products, such as computers, televisions, mobile phones, and so on. With the development of flat panel display technology, displays such as liquid crystal displays (LCD), plasma display panels (PDP), and organic light emitting diodes (OLED) are currently used. In addition, advances in image processing technology and display technology has permitted an increase in the resolution of the display, such that images can be displayed with good quality.

However, for these types of flat panel display apparatuses, the images are displayed in a limited area defined by the size of the display panel. Therefore, the audiences may not be able to obtain a large size image when they are watching films or playing games.

Therefore, what is needed in the industry is to provide an improved display apparatus that the audiences can obtain a large size image displayed by the display apparatus.

### SUMMARY

Accordingly, a display apparatus is provided. In an exemplary embodiment, the display panel includes a display panel and a front cover. The display panel is used for displaying images. The front cover is attached to the display panel and arranged with a plurality of hybrid modules. The hybrid modules is used for sensing primary light emitted from side portions of the display panel and emitting secondary light with substantially the same color and luminous intensity as the primary light.

### BRIEF DESCRIPTION OF THE DRAWINGS

FIG. 1 is a front view of a display apparatus comprising a hybrid module.

FIG. 2 is a cross-sectional view taken along a line II-II of a first embodiment of the display apparatus in FIG. 1.

FIG. 3 is a cross-sectional view taken along a line II-II of a second embodiment of the display apparatus in FIG. 1.

FIG. 4 illustrates a general block diagram of the hybrid module together with other elements of the display apparatus in FIG. 1.

FIG. 5 is a detailed block diagram of a first embodiment of the hybrid module together with other elements in FIG. 4.

FIG. 6 is a detailed block diagram of a second embodiment of the hybrid module together with other elements in FIG. 4.

### DETAILED DESCRIPTION

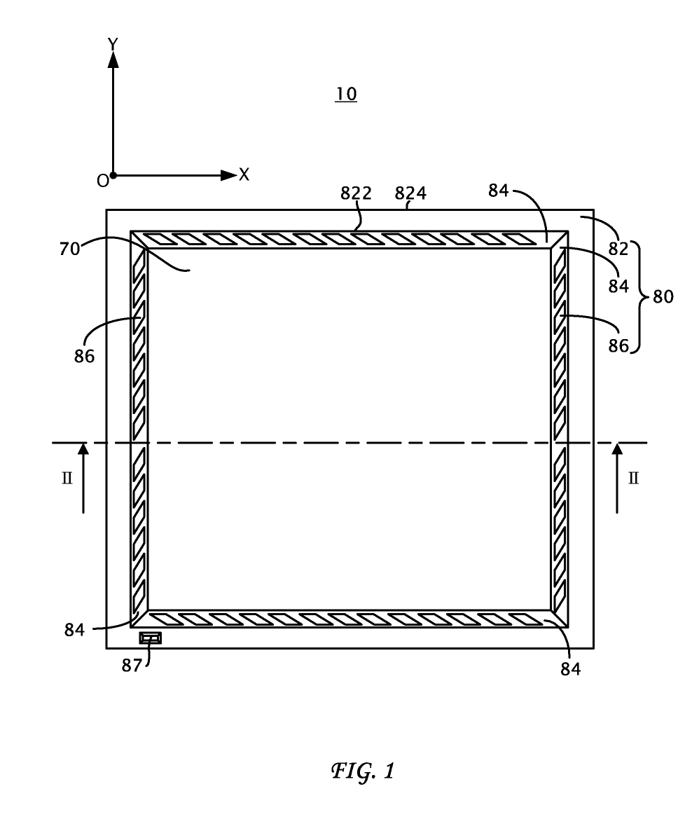

Referring to FIG. 1, a display apparatus 10 in accordance with an exemplary embodiment includes a display panel 70 and a front cover 80. The display panel 70 is accommodated in a space defined by an assembled casing formed by the front cover 80 and a rear cover (not shown). The display panel 70 is configured for displaying images in a two dimensional plane that is indicated by a Cartesian two-dimensional X-Y coordinate system.

The front cover 80 is defined with an opening (not labeled) in an approximately central portion for light to pass through. The front cover 80 includes a top surface 82, four sloping extensions 84, and a plurality of hybrid modules 86. The platform 82 is a rectangular frame and includes an inner edge 822 and an outer edge 824. Each sloping extension 84 extends from an inner edge 822 of the top surface 82 and slopes towards the display panel 70. In other words, each sloping extension 84 extends radially out of the display panel 70.

The hybrid module 86 is configured for receiving primary light emitted from side portions of the display panel 70 and detecting color and luminous intensity of the received primary light. The hybrid module 86 is also configured for emitting secondary light with similar color and luminous intensity corresponding to the received primary light.

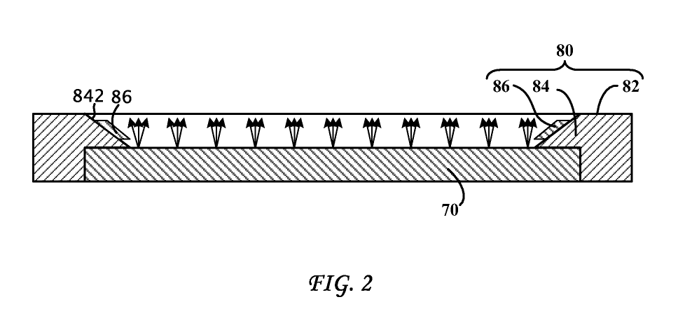

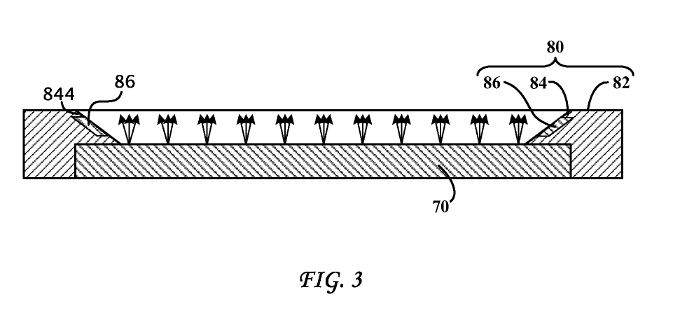

Referring to FIG. 2 and FIG. 3, a hybrid module 86 may be attached to either an outside surface 842 or an inside surface 844 of each sloping extension 84. When the hybrid module 86 is attached to the inside surface 844 of the sloping extension 84, the sloping extension 84 is preferably made of translucent material. Therefore, the secondary light emitted from the hybrid module 86 can travel through the sloping extension 84. It should be noted that in other embodiments the hybrid module 86 can be arranged at both the inside surface 844 and the outside surface 842 of the sloping extension 84.

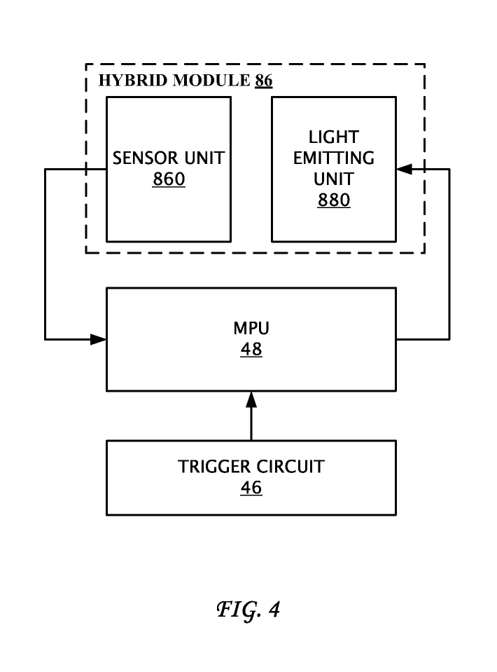

Referring to FIG. 4, each hybrid module 86 includes a sensor unit 860 and a light emitting unit 880. The sensor unit 860 and the light emitting unit 880 are electrically connected to a micro processing unit (MPU) 48 of the display apparatus 10. The sensor unit 860 is configured for receiving a portion of the primary light emitted from the display panel 70. The sensor unit 860 converts the received primary light to electrical signals and transmits the electrical signals to the MPU 48. The MPU 48 drives the light emitting unit 880 to emit the secondary light having similar color and luminous intensity corresponding to the primary light according to the electrical signals transmitted from the sensor unit 860.

The MPU 48 is also connected to a trigger circuit 46 of the display apparatus 10. The trigger circuit 46 may be a switch that can be actuated to enable or disable the hybrid module 86. Such a switch function may be achieved by arranging a button in a remote control (not shown) or by arranging a button 87 (see FIG. 1) on the front cover 80 of the display apparatus 10.

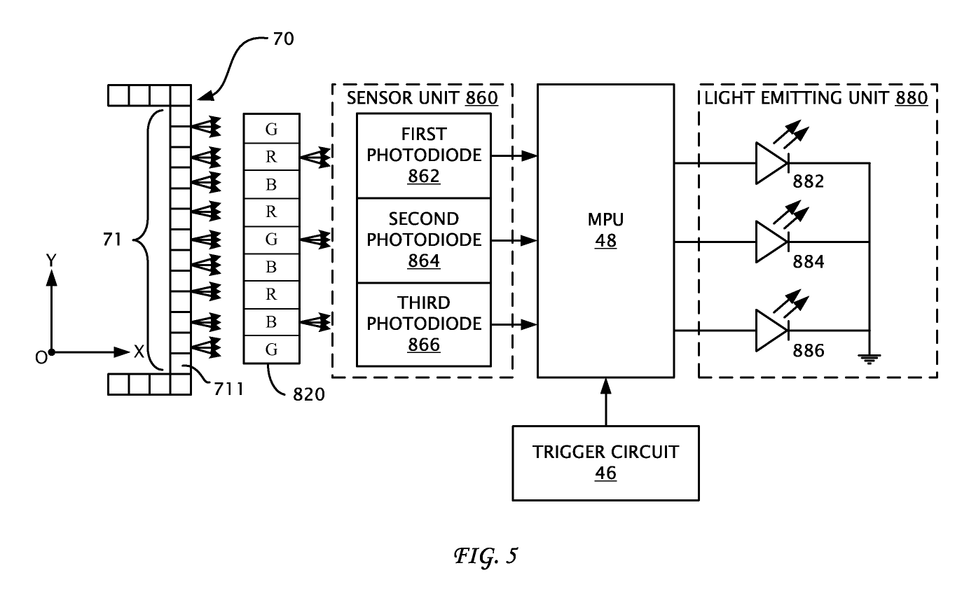

Referring to FIG. 5, the display panel 70 is a pixel array type and includes a plurality of pixel units 711. Taking the LCD type display panel 70 as an example, each pixel unit 711 includes a plurality of liquid crystal molecules that can be controlled by voltage signals. An alignment direction of the molecules varies in response to the voltage signals to block light from passing through or allow light to pass through, such that images are constructed accordingly.

In a first embodiment, the display panel 70 is divided into a plurality of pixel regions 71 including a predetermined amount of pixel units 711 along side portions of the display panel 70. For example, each pixel region 71 includes ten pixel units 711 or so. A sensor unit 860 and a light emitting unit 880 are arranged in the proximity of each pixel region 71 correspondingly. By this arrangement, each sensor unit 860 is capable of sensing luminous intensity of the primary light emitted from a corresponding pixel region 71. Each light emitting unit 880 is driven to emit secondary light with similar luminous intensity of the corresponding pixel region 71. When the audiences watch a lawn image displayed by the display panel 70, a side portion of the image displayed by display panel 70 is extended by the secondary light emitted from the hybrid modules 86. As a result, a large size image, for example, an extended lawn scene is perceived by the audiences.

The sensor unit 860 includes three photodiodes (PDs) for sensing the primary light, i.e. a first PD 862, a second PD 864, and a third PD 866. In the exemplary embodiment, the first PD 862, the second PD 864, and the third PD 866 are configured for sensing red light, green light, and blue light respectively. Such that, the color of the primary light emitted from each pixel region 71 can be detected. Each of the three photodiodes can output an electric current proportional to luminous intensity of the primary light projected onto the photodiode, such that the luminous intensity of the primary light emitted from each pixel region 71 can be detected.

The light emitting unit 880 includes three light emitting diodes (LED) i.e., a first LED 882, a second LED 884, and a third LED 886 for emitting the secondary light. The first LED 882, the second LED 884, and the third LED 886 have their anodes electrically connected to the MPU 48, and their cathodes grounded. The secondary light can be outputted light with different color and luminous intensity by applying/supplying various voltages or current to the first LED 882, the second LED 884, and the third LED 886.

Hereinafter, an operation of the display apparatus 10 of the first embodiment will be described. In the first embodiment, the hybrid module 86 is enabled by the trigger circuit 46.

In operation, the display panel 70 displays a 2D image in a two-dimensional X-Y plane by controlling each pixel unit 711 to emit or not emit the primary light. The primary Light emitted from each pixel region 71 is received by the corresponding sensor unit 860 when the hybrid module 86 is enabled. The first PD 862 of each sensor unit 860 senses the red light component and outputs a first electrical signal. The second PD 864 of each sensor unit 860 senses the green light component and outputs a second electrical signal. The third PD 866 of each sensor unit 860 senses the blue light component and outputs a third electrical signal. The amplitudes of the first, the second, and the third electrical signals represent the luminous intensity of the primary light projected thereto respectively.

The MPU 48 supplies electrical currents to the first LED 882, the second LED 884, and the third LED 886 respectively in response to the first electrical signals, the second electrical signals and the third electrical signals. The first LED 882, the second LED 884, and the third LED 886 emit the secondary light having different colors and luminous intensity with the electrical current supplied thereto. For example, the first LED 882 emits red light with similar luminous intensity to the light sensed by the first PD 862. The second LED 884 emits green light with similar luminous intensity to the light sensed by the second PD 864. The third LED 886 emits blue light with similar luminous intensity to the light sensed by the third PD 866. The red light, the green light, and the blue light emitted from the first LED 882, the second LED 884, and the third LED 886 mix together to produce a light of similar color and luminous intensity corresponding to each pixel region 71.

Therefore, the primary light of the 2D image is mixed/combined with the secondary light around the sides of the 2D image. The secondary light emitted from the light emitting unit 880 disposed at the sloping extension 84 is aimed at a different direction compared to adjacent pixel region 71 of the display panel 70 correspondingly. As such, a partial holographic 3D image can be obtained by the audience.

Referring to FIG. 5, the sensor unit 860 of the hybrid module 86 may further include a plurality of color filters 820. Each color filter 820 is disposed between the pixel region 71 and the corresponding sensor unit 860. The color filter 820 includes periodically formed color layers R, G, B for filtering the red light, the green light, and the blue light to the first PD 862, the second PD 864, and the third PD respectively.

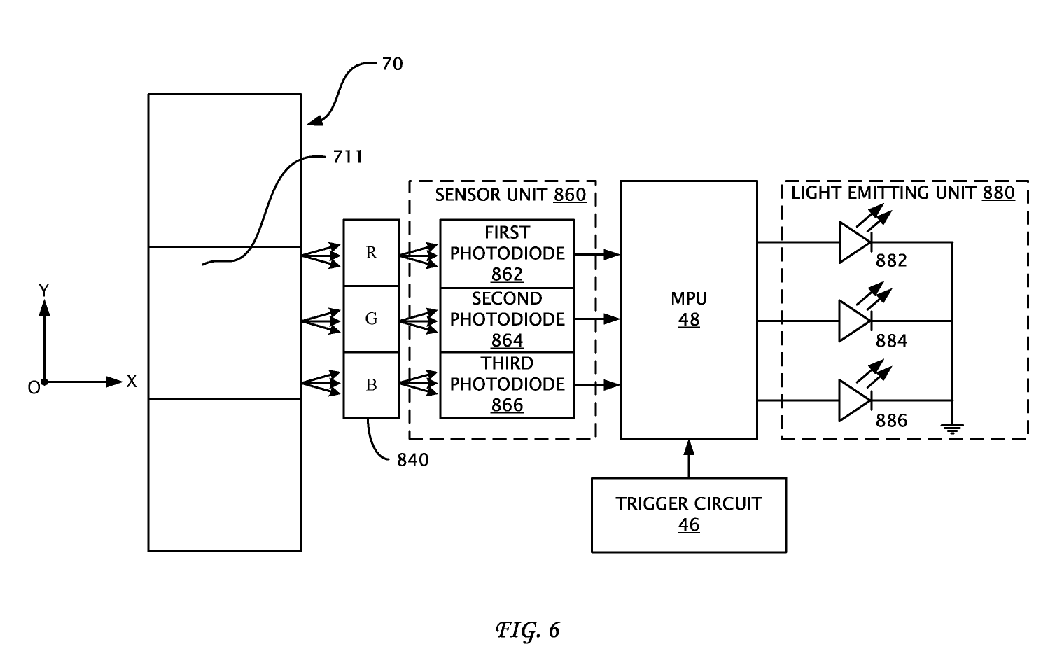

Referring to FIG. 6 in a second embodiment, each pixel unit 711 of the display panel 70 is arranged with a sensor unit 860 and a light emitting unit 880. That is, the primary light emitted from each pixel unit 711 is received by the corresponding sensor unit 860. The sensor unit 860 transmits electrical signals generated from the sensed primary light to the MPU 48. The MPU 48 drives the light emitting unit 880 to emit similar color and luminous intensity of the secondary light based on the electrical signals.

In operation of the second embodiment, a side portion of the image displayed by display panel 70 is also extended by the secondary light emitted from the hybrid modules 86. As a result, a large size image, for example, an extended lawn scene is perceived by the audiences with the two substantially same images.

Alternative embodiments will become apparent to those skilled in the art to which the present invention pertains without departing from its spirit and scope. For example, the electrical signals output from the first PD 862, the second PD 864, and the third PD 866 are taken a form of electrical currents according to a photo electric effect. It should be noted that the electrical currents corresponding to the luminous intensity of the light coming from each pixel region 71 may be converted to electrical voltages by appropriately arranged circuitry. The electrical voltages may also be amplified before being received by the MPU 48 or amplified by internal circuitry of the MPU 48.

What is claimed is:

1. A display apparatus, comprising:
a display panel for displaying images thereon;
a front cover attached to the display panel and arranged with a plurality of hybrid modules, the hybrid modules senses primary light emitted from a side portion of the display panel adjacent to the hybrid modules and the hybrid modules emits secondary light around the side portion of the display panel with substantially same color and luminous intensity as the primary light.

2. The display apparatus as claimed in claim 1, wherein the front cover comprises a plurality of sloping extensions, the sloping extensions extend obliquely with respect to a two dimensional plane of the display panel, and at least one of the sloping extensions is arranged with the hybrid modules.

3. The display apparatus as claimed in claim 2, wherein the hybrid module is disposed at a front surface of the sloping extension.

4. The display apparatus as claimed in claim 2, wherein the hybrid module is disposed at a back surface of the sloping extension.

5. The display apparatus as claimed in claim 4, wherein the sloping extension is made of translucent material.

6. The display apparatus as claimed in claim 1, wherein the hybrid module comprises:
a sensor unit for receiving the primary light and outputting electrical signals representing color and luminous intensity characteristic of the primary light;
a micro processing unit for receiving the electrical signals from the sensor unit;
a light emitting unit for being driven to emit the secondary light of similar color and luminous intensity based on the electrical signals.

7. The display apparatus as claimed in claim 6, wherein the pixel region comprises at least one pixel unit.

8. The display apparatus as claimed in claim 6, wherein the hybrid module further comprises a plurality of color filters, and each color filter is disposed between the pixel region being sensed and the corresponding sensor unit.

9. The display apparatus as claimed in claim 1 further comprising a trigger circuit coupled to the hybrid module and actuated to enable or disable the hybrid module.

10. A display apparatus, comprising:
a display panel for displaying images in a two dimensional plane; and
a front cover, comprising:
a platform extending parallel with the two dimensional plane; and
a plurality of sloping extensions extending obliquely relative to the platform from an internal edge of the platform, the sloping extensions being arranged with a plurality of photodiodes and corresponding light emitting diodes, the photodiodes sensing primary light emitted from a side portion of the display panel, the corresponding light emitting diodes emitting secondary light with substantially same color and luminous intensity of the primary light.

11. The display apparatus as claimed in claim 10, wherein the photodiodes and light emitting diodes pairs are arranged at a front surface of the sloping extension.

12. The display apparatus as claimed in claim 10, wherein the photodiodes and the corresponding light emitting diodes are arranged at a back surface of the sloping extension.

13. The display apparatus as claimed in claim 12, wherein the sloping extension is made of translucent material.

14. The display apparatus as claimed in claim 10, further comprises a plurality of color filters, each color filter being disposed between the side edge portions being sensed and the corresponding photodiodes.

15. The display apparatus as claimed in claim 10, wherein the photodiodes and the light emitting diodes are coupled between a micro processing unit.

16. The display apparatus as claimed in claim 11, wherein the display apparatus further comprises a trigger circuit, the trigger circuit is electrically connected to the micro processing unit for inputting ON or OFF signals to the MPU to enable or disable the photodiodes.
